(19) United States
(12) Patent Application Publication
(10) Pub. No.: US 2005/0114764 A1
(43) Pub. Date: May 26, 2005

(54) Producing a page of information based on a dynamic edit form and one or more transforms

(76) Inventors: John C. Gudenkauf, Bellevue, WA (US); Victus Yuk-Lun Wong, Seattle, WA (US); Stephen J. Butler, Bellevue, WA (US)

Correspondence Address: WOODCOCK WASHBURN LLP, ONE LIBERTY PLACE - 46TH FLOOR, PHILADELPHIA, PA, 19103, US

(21) Appl. No.: 10/721,146

(22) Filed: Nov. 25, 2003

(51) Int. Cl. G06F 17/21; G06F 17/24

(52) U.S. Cl. 715/517; 715/530

(57) ABSTRACT

An editing process receives a piece of content including at least one item therein, an edit form including at least one control available for receiving an item and for specifying attributes relating to displaying the received item in a page, and a content-control statement specifying for each of at least some items a control from the edit form to be employed to display the item in the page. An editor creates/edits a layout statement specifying each item to appear in the page, including a layout order and any attributes to be applied. The editing process outputs the edited layout statement and edited content. The edited content is an intermediate form of the content based on at least the edit form and the content-control statement, where a transforming process is to produce the page based on the edited content, the layout information, and a pre-selected rendering format.

### CROSS-REFERENCE TO RELATED APPLICATIONS

The present application is related to U.S. patent application Ser. No. ______, filed concurrently with the present application under attorney docket number MSFT-2755 and entitled “PRODUCING A PAGE OF INFORMATION BASED ON A DYNAMIC EDIT FORM AND ONE OR MORE TRANSFORMS”, hereby incorporated herein by reference in its entirety.

### TECHNICAL FIELD

The present invention relates to a system for generating a page such as a page to be served over a network for publishing content to the network in a dynamic manner. More specifically, the present invention relates to such a system that allows an editor to dynamically edit an edit form and that allows the use of one or more transforming statements independent of the edited edit form.

### BACKGROUND OF THE INVENTION

In very general terms, content may be published to a network such as the Internet by applying the content to an edit form to produce a page of information including the content, and then storing the page on an appropriate server from which such page with such content can be requested. The edit form typically is constructed to have predefined fields or ‘controls’, where each control is to contain at least a portion of the content and/or additional information relating 8to the content. For example, if the server is run by or an behalf of a newspaper publisher for the purpose of serving newspaper articles, a newspaper editor may publish a newspaper article to the network by applying the contents of the article and the additional information to an edit form to produce the article in a format defined by the edit form.

The edit form employed to publish the newspaper article may for example include one or more fields for entering an article title and/or subtitle, one or more fields for entering an article summary, one or more fields for entering the text of the article, one or more fields for entering pictures to accompany the text, one or more fields for entering multimedia content to accompany the text, one or more fields for entering a web link at which related information may be found, one or more fields for entering feedback information, one or more fields for entering author information, and the like. As may be appreciated, each such field in the edit form in general is for receiving some sort of information that is to be displayed or otherwise presented to a client requesting the article from the server.

Thus, the aforementioned newspaper editor may for example copy the content into some of the fields, such as the title and text fields, add additional text content to some of the fields, such as the summary, author, and feedback fields, add additional content to some of the fields, such as the picture and multimedia fields, and the like. As may also be appreciated, in the edit form, each field typically includes therein definitional attributes, including location information for locating the field on the published article as served to a requesting client, font and font size information for specifying a font and font size if the field is textual, color information for specifying a color if necessary or advisable, style information for specifying a style, and/or the like as necessary.

Thus, the newspaper editor publishing the content to a page on the server need only select a particular edit form to choose many aspects of a particular page, where the chosen edit form specifies many details relevant to the published page. In addition, and significantly, the newspaper editor need not be concerned with every such detail. As should be understood, then, the edit form may be employed to simplify the task of publishing the page by the newspaper editor, and also may be employed to enforce a particular ‘look and feel’ across multiple published newspaper pages available to a client from the server.

Many systems and methods exist for developing edit forms, each of which is generally based on a requirement to build an edit form to encapsulate the writing of related data (newspaper article text and related information, e.g.) from an entry point (a newspaper editor, e.g.) to a destination document (a page of information, e.g.) in a data store (a newspaper server, e.g.), where the data store can then send the destination document to a requesting client (a network client on a network such as the Internet, e.g.). Typically, each edit form is custom in nature in that the edit form is designed and developed to solve a very specific need. Accordingly, and as a result, each edit form is static in nature in that most if not all of the definitional attributes of the fields therein are fixed and non-variable.

As should be evident, then, such a static edit form does not provide the ability to alter the fields defined therein to provide additional functionality or to facilitate developing additional edit forms in a flexible and efficient manner. As should also be evident, then, the development time for developing a new static edit form is often relatively costly in terms of time and effort. Put another way, if the newspaper editor employing a particular static edit form with two picture fields instead wishes to have three picture fields, such editor cannot merely modify the static edit form to accommodate three pictures. At best, such editor must select another static edit form having three picture fields. However, such an edit form may not be available to the editor, or may be available but with other unwanted fields or with a lack of other wanted fields. At worst, the editor must commission a developer to develop a particular static edit form having the characteristics and edit fields desired.

Solutions do exist that allow a developer to develop edit forms in a relatively quicker fashion by providing the aforementioned controls to choose from and by having the ability to place each control into an edit form under development. Additional functionality is then developed to give behavior and coherency to the user experience. This reduces the time to prototype and ultimately to develop the current and future user forms.

With the advent of the Internet, the edit form has changed to a browser-friendly platform. In addition, standards like XML (extensible Markup Language) have allowed user-interface developers to define metadata (data about data) to help in transforming XML into HTML (Hyper-Text Markup Language) that may be rendered by a browser and in this regard provide the ability to generate an edit form. In basic terms, the XML definition is provided as input to a transform that converts the XML definition into an HTML page. Although an astute method of developing dynamic forms, the layout formatting provided by the transform is very intertwined with the HTML language and is often not able to be reused due to the specific targeting nature of the layout formatting. As a result, a person such as the newspaper editor set forth above does not likely have the ability to design and modify an edit form in a dynamic manner.

Accordingly, a need exists for a user experience that may be employed by a person such as the newspaper editor to design and modify an edit form in a dynamic manner, and to transform an XML definition of the edit form or the like into an HTML page or the like representing a final rendered user experience.

### SUMMARY OF THE INVENTION

The aforementioned needs are satisfied at least in part by the present invention in which a computing system having an editing process operating thereon is provided. The editing process receives a selection of (1) a piece of content including at least one item therein, where each item specifies a pre-defined portion of the content; (2) an edit form including at least one control therein, where each control is available for receiving an item of the content and for specifying attributes relating to displaying the received item in a page that is to be served to a requester thereof; and (3) a content-control statement specifying for each of at least some items of the content a control from the edit form to be employed to display the item in the page and thereby binding the content to the edit form.

In addition, the editing process either receives a selection of a layout statement or allows an editor to create the layout statement, where the layout statement specifies each item of the content that is to appear in the page, including a layout order of such specified item within the page and any attributes to be applied to such item. Thereafter, the editing process facilitates the editor in editing the layout statement to edit how the content is to appear in the page, and outputs the edited layout statement and edited content. The edited content is an intermediate form of the content based on at least the edit form and the content-control statement, where a transforming process is to produce the page based on the edited content, the layout information, and a pre-selected rendering format.

### BRIEF DESCRIPTION OF THE DRAWINGS

The foregoing summary, as well as the following detailed description of the embodiments of the present invention, will be better understood when read in conjunction with the appended drawings. For the purpose of illustrating the invention, there are shown in the drawings embodiments which are presently preferred. As should be understood, however, the invention is not limited to the precise arrangements and instrumentalities shown. In the drawings:

FIG. 1 is a block diagram representing a general purpose computer system in which aspects of the present invention and/or portions thereof may be incorporated;

FIGS. 2A and 2B are block diagrams showing inputs and outputs to an editing process (FIG. 2A) and a transforming process (FIG. 2B) in accordance with one embodiment of the present invention; and

FIG. 3 is a flow diagram showing key steps performed in connection with the processes of FIGS. 2A and 2B in accordance with one embodiment of the present invention.

### DETAILED DESCRIPTION OF THE INVENTION

Computer Environment

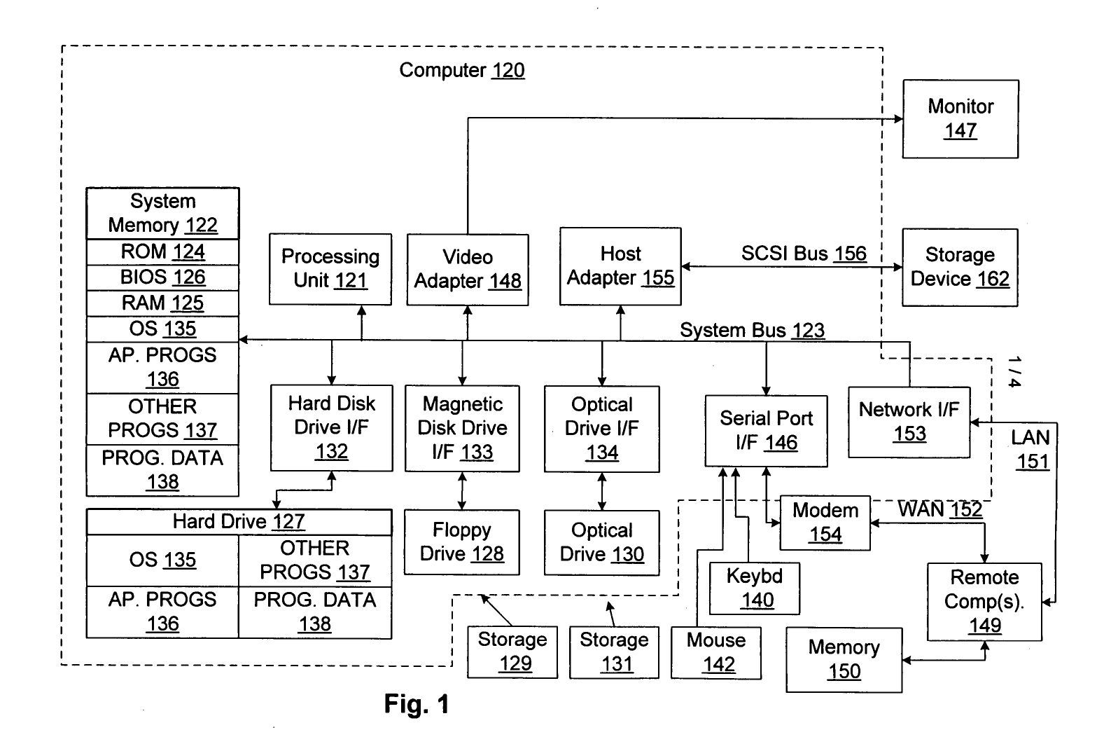

FIG. 1 and the following discussion are intended to provide a brief general description of a suitable computing environment in which the present invention and/or portions thereof may be implemented. Although not required, the invention is described in the general context of computer-executable instructions, such as program modules, being executed by a computer, such as a client workstation or a server. Generally, program modules include routines, programs, objects, components, data structures and the like that perform particular tasks or implement particular abstract data types. Moreover, it should be appreciated that the invention and/or portions thereof may be practiced with other computer system configurations, including hand-held devices, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

As shown in FIG. 1, an exemplary general purpose computing system includes a conventional personal computer 120 or the like, including a processing unit 121, a system memory 122, and a system bus 123 that couples various system components including the system memory to the processing unit 121. The system bus 123 may be any of several types of bus structures including a memory bus or memory controller, a peripheral bus, and a local bus using any of a variety of bus architectures. The system memory includes read-only memory (ROM) 124 and random access memory (RAM) 125. A basic input/output system 126 (BIOS), containing the basic routines that help to transfer information between elements within the personal computer 120, such as during start-up, is stored in ROM 124.

The personal computer 120 may further include a hard disk drive 127 for reading from and writing to a hard disk (not shown), a magnetic disk drive 128 for reading from or writing to a removable magnetic disk 129, and an optical disk drive 130 for reading from or writing to a removable optical disk 131 such as a CD-ROM or other optical media. The hard disk drive 127, magnetic disk drive 128, and optical disk drive 130 are connected to the system bus 123 by a hard disk drive interface 132, a magnetic disk drive interface 133, and an optical drive interface 134, respectively. The drives and their associated computer-readable media provide non-volatile storage of computer readable instructions, data structures, program modules and other data for the personal computer 120.

Although the exemplary environment described herein employs a hard disk, a removable magnetic disk 129, and a removable optical disk 131, it should be appreciated that other types of computer readable media which can store data that is accessible by a computer may also be used in the exemplary operating environment. Such other types of media include a magnetic cassette, a flash memory card, a digital video disk, a Bernoulli cartridge, a random access memory (RAM), a read-only memory (ROM), and the like.

A number of program modules may be stored on the hard disk, magnetic disk 129, optical disk 131, ROM 124 or RAM 125, including an operating system 135, one or more application programs 136, other program modules 137 and program data 138. A user may enter commands and information into the personal computer 120 through input devices such as a keyboard 140 and pointing device 142. Other input devices (not shown) may include a microphone, joystick, game pad, satellite disk, scanner, or the like. These and other input devices are often connected to the processing unit 121 through a serial port interface 146 that is coupled to the system bus, but may be connected by other interfaces, such as a parallel port, game port, or universal serial bus (USB). A monitor 147 or other type of display device is also connected to the system bus 123 via an interface, such as a video adapter 148. In addition to the monitor 147, a personal computer typically includes other peripheral output devices (not shown), such as speakers and printers. The exemplary system of FIG. 1 also includes a host adapter 155, a Small Computer System Interface (SCSI) bus 156, and an external storage device 162 connected to the SCSI bus 156.

The personal computer 120 may operate in a networked environment using logical connections to one or more remote computers, such as a remote computer 149. The remote computer 149 may be another personal computer, a server, a router, a network PC, a peer device or other common network node, and typically includes many or all of the elements described above relative to the personal computer 120, although only a memory storage device 150 has been illustrated in FIG. 1. The logical connections depicted in FIG. 1 include a local area network (LAN) 151 and a wide area network (WAN) 152. Such networking environments are commonplace in offices, enterprise-wide computer networks, intranets, and the Internet. The personal computer 120 may also act as a host to a guest such as another personal computer 120, a more specialized device such as a portable player or portable data assistant, or the like, whereby the host downloads data to and/or uploads data from the guest, among other things.

When used in a LAN networking environment, the personal computer 120 is connected to the LAN 151 through a network interface or adapter 153. When used in a WAN networking environment, the personal computer 120 typically includes a modem 154 or other means for establishing communications over the wide area network 152, such as the Internet. The modem 154, which may be internal or external, is connected to the system bus 123 via the serial port interface 146. In a networked environment, program modules depicted relative to the personal computer 120, or portions thereof, may be stored in the remote memory storage device. It will be appreciated that the network connections shown are exemplary and other means of establishing a communications link between the computers may be used.

Dynamic Edit Form Generation

In summary, in the present invention, XML metadata or the like is employed to describe the behavior and binding to data in a cohesive meta-language as input to a process to generate a dynamic user interface. As may be appreciated, utilizing an XML syntax or the like to describe edit form controls and the behavior of such controls allows such process to cache the controls defined in the XML or the like, to define the binding of each control to the actual XML data or the like to be stored, to define the cardinality of each control, and to group repeating items, among other things.

Defining a robust XML syntax or the like that can be used to rapidly develop edit forms significantly reduces development time. Edit forms can be developed and deployed almost simultaneously as the requirements are captured. By placing appropriate logic in the process, flexibility, reuse, and performance is increased as opposed to applying transforms to generate HTML output.

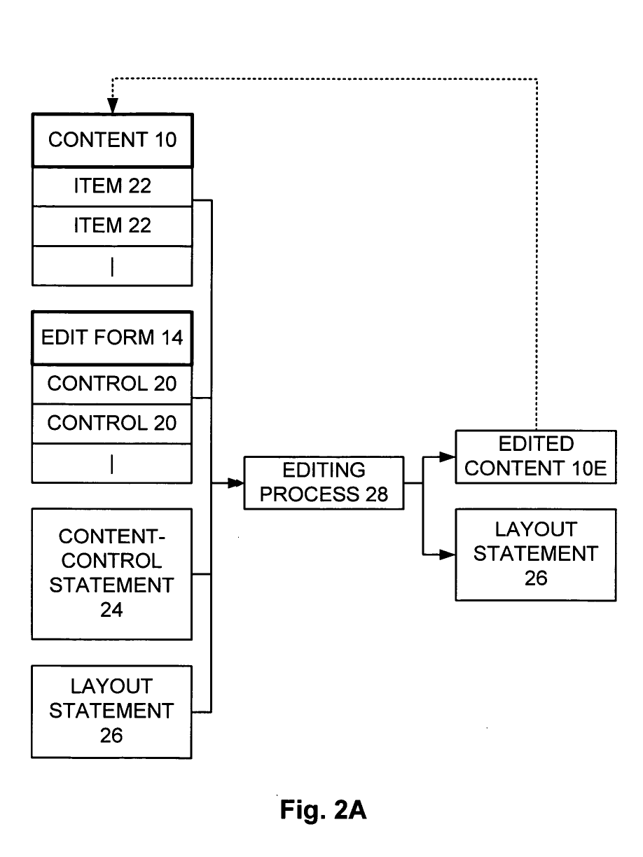

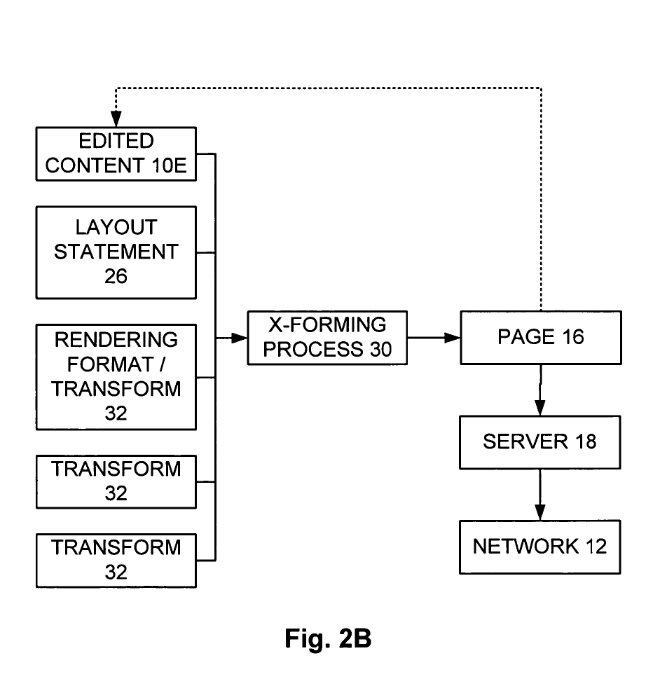

In one embodiment of the present invention, and turning now to FIGS. 2A and 2B, content 10 is published to a network 12 such as the Internet by applying the content 10 with an edit form 14 to produce a page 16 of information including the content 10, and then storing the page 16 on an appropriate server 18 from which such page 16 with such content 10 can be requested. Significantly, and as will be set forth in more detail below, the edit form 14 is dynamic in nature in that such edit form 14 sets forth available controls 20 and for each such control 20 attributes thereof such as a minimum and maximum number thereof that may appear on the page 16. Thus, the controls 20 of the edit form 14 are available to an individual such as an editor in defining the page 16 based on the content 10, but are not necessarily required to be used, and if used are not necessarily required to be used in any particular order.

In one embodiment of the present invention, the content 10 is sub-divided into items 22, and in addition to the edit form 14, a content-control statement 24 is employed to specify for at least some items 22 of the content 10 a specific control 20 from the edit form 14 that is to be employed to display the item 22 in the page 16. Also in addition to the edit form 14, a layout statement 26 is employed to specify each item 22 of the content 10 that is to appear in the page 16, and in particular the layout order of such specified items 22 from the content 10 within the page 16 and perhaps attributes to be applied to each such laid-out item 22. Note that each item 22 of content 10 is not necessarily required to be used in the page 16, and if used is not necessarily required to be used in any particular order.

Thus, and as may be appreciated, the content 10, the edit form 14, the content-control statement 24, and the layout statement 26 are all employed to produce the page 16. As may be appreciated, by separating the information in the content-control statement 24 and the information in the layout statement 26 from the other information incumbent in the content 10 and the edit form 14, the edit form in particular can be much more dynamic in nature in that such edit form need only specify the controls 20, and not any particular order of controls 20, any specific number of controls 20, which control 20 is to be employed for a particular item 22 of content 10, etc. Instead, such edit form 14 can be applied to multiple types of content 10, where each type of content 10 is specified in relation to the edit form 14 by way of a content-control statement 24 that implicitly binds the type of content 10 to the edit form 14. Moreover, multiple layouts of the content 10 according to the edit form 14 can be achieved by specifying a particular layout statement 26 for each such layout of the content. Further, it is to be appreciated, that each layout statement 26 is not necessarily bound to a particular edit form 14 and therefore can be employed with respect to any of multiple edit forms 14.

In one embodiment of the present invention, and as seen in FIGS. 2A and 2B, an individual such as an editor may publish the content 10 to a page 16 by way of an editing process 28 (FIG. 2A) and a transforming process 30 (FIG. 2B), where each of the editing process 28 and the transforming process 30 is an application or the like operating on an appropriate computing device such as computer 120 of FIG. 1 or the like. Note that the editing process 28 and the transforming process 30 may be performed on the same computing device or different computing devices by the same person or by different people without departing from the spirit and scope of the present invention.

As may be appreciated, the editing process 28 in particular receives the content 10, the edit form 14, the content-control statement 24, and perhaps the layout statement 26 and facilitates the editor in editing how the content 10 is to appear on the page 16. Thus, the editing process 28 may for example include a user interface (UI) setting forth editable attributes of the edit form 14, a UI setting forth each item 22 of content 10, a UI setting forth the content-control statement 24, a UI setting forth the layout statement 26 if present, and a UI setting forth the page 16 based on the content 10, the edit form 14, the content-control statement 24, and the layout statement 26. As may be appreciated, each of the edit form 14, the content 10, the content-control statement 24, the layout statement 26, and the page 16 may be set forth according to a computer-based markup language such as an XML or the like, and accordingly each corresponding UI should represent the corresponding markup language in a graphical form and if necessary allow editing of the corresponding markup language in a graphical form.

Note with particular regard to the layout statement 26 that most if not all modifications made by the editor with respect to the content 10 on the page 16 are with respect to such layout statement 26. Accordingly, the editor editing a particular piece of content 10 based on an edit form 14 and a content-control statement 24 binding same may choose to start with an already-existing layout statement 26 and modify same or may choose to construct a new layout-statement 26. In either case, the editing process 28 allows the editor to save a new or modified layout statement 26 for later retrieval and re-use.

In one embodiment of the present invention, the output of the editing process 28, is the saved layout statement 26 and edited content 10e. Such edited content 1oe is not the page 16 but is an intermediate form of the content 10 that takes into consideration the edit form 14, the content-control statement 24 and perhaps the layout statement 26, but that does not have any particular rendering format such as HTML or the like. For example, the edited content 10e as outputted by the editing process 28 may have a neutral format such as XML. Accordingly, such rendering format may be applied at a later time to the edited content 10e. Moreover, multiple rendering formats may be applied to the same edited content 10e to produce corresponding pages 16, where each such page 16 has the same edited content 10e transformed according to the corresponding rendering format.

Note that in one embodiment of the present invention, the edited content 10e as produced by the editing process 28 is distinct from the layout statement 26 produced by such editing process 28 in that the information in the layout statement 26 has not as yet been incorporated into the edited content 10e. Instead, the edited content 10e is based only on the content 10, the edit form 14, and the content-control statement 24. In such situation, then, the edited content 10e includes at a minimum only those items 22 of the content 10 and only those controls 20 of the edit form 14 that are referenced by the content-control statement 24, and other necessary information. As seen below, the information in the layout statement 26 is to be applied by the transforming process 30 of FIG. 2B. Of course, the edited content 10e could also incorporate some or all of the information in the layout statement 26 as necessary and/or desirable without departing from the spirit and scope of the present invention.

Generally, all functions that are to be performed by the editing process 28 of FIG. 2A are known or should be apparent to the relevant public and therefore need not be set forth herein in any detail. Accordingly, any appropriate type or construction of editing process 28 may be employed without departing from the spirit and scope of the present invention.

As should now be evident, and bearing in mind that the output of the editing process 28 is the format-neutral edited content 10e and the layout statement 26, the transforming process 30 of FIG. 2B is employed to produce the page 16 from such edited content 10e and such layout statement 26 according to a pre-selected format such as HTML. As seen in FIG. 2B, such rendering format 32 is applied as a transforming input to the transforming process 30 along with the edited content 10e and the layout statement 26. Note that the transforming process 30 could also be employed to receive the edited content 10e and multiple inputted rendering formats 32, where the transforming process 30 produces a page 16 corresponding to each inputted rendering format 32 based on the edited content 10e and the layout statement 26.

Generally, all functions that are to be performed by the transforming process 30 of FIG. 2B are known or should be apparent to the relevant public and therefore need not be set forth herein in any detail. Accordingly, any appropriate type or construction of transforming process 30 may be employed without departing from the spirit and scope of the present invention.

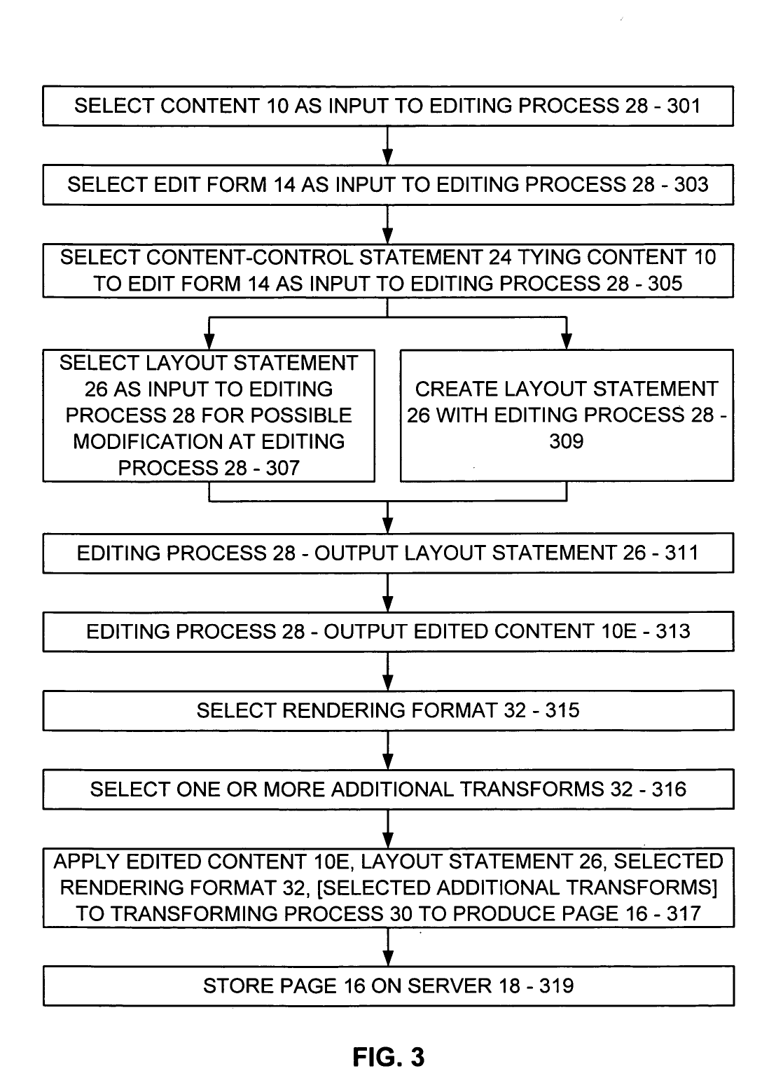

Turning now to FIG. 3, a method of producing a page 16 based on content 10 and a dynamic edit form 14 is shown. Preliminarily, and as should be appreciated, an editor at the editing process 28 of FIG. 2A selects content 10 to be inputted to the editing process 28 (step 301). An example of content 10 that is to be inputted to the editing process 28 of FIG. 2A in an XML format is set forth:

```
<?xml version=“1.0” encoding=“utf-8” ?>
<cp:CONTENT xmlns:msxsl=“urn:schemas-microsoft-com:xslt”
xmlns:xsi=“http://www.w3.org/2001/XMLSchema-instance”
xmlns:cp=“urn:schemas-microsoft-com/contentpublishing/content”
xmlns:g=“urn:schemas-microsoft.com/contentpublishing/g”
xmlns:xhtml=“http://www.w3.org/1999/xhtml” xmlns:gitize=
“urn:schemas-
microsoft.com/contentpublishing/gitize”>
    <cp:CONTENTITEM>
        <cp:HEADLINE>Sample Text line number 1</cp:HEADLINE>
    </cp:CONTENTITEM>
    <cp:CONTENTITEM>
        <cp:HEADLINE>Sample Text line number 2</cp:HEADLINE>
    </cp:CONTENTITEM>
    <cp:CONTENTITEM>
        <cp:HEADLINE>http://www.msn.com</cp:HEADLINE>
        <cp:URL gitize:type=“normal” />
        <cp:DATA>
            <g:link>
                <g:tag g:name=“DPI” g:value=“” />
                <g:tag g:name=“DNC” g:value=“” />
                <g:tag g:name=“DPS” g:value=“” />
                <g:tag g:name=“DDI” g:value=“” />
                <g:tag g:name=“GT1” g:value=“” />
                <g:tag g:name=“GT2” g:value=“” />
                <g:tag g:name=“GT3” g:value=“” />
                <g:tag g:name=“GT4” g:value=“” />
                <g:tag g:name=“GT5” g:value=“” />
            </g:link>
        </cp:DATA>
    </cp:CONTENTITEM>
    <cp:CONTENTITEM>
        <cp:HEADLINE>http://www.microsoft.com</cp:HEADLINE>
        <cp:URL gitize:type=“normal” />
        <cp:DATA>
            <g:link>
                <g:tag g:name=“DPI” g:value=“” />
                <g:tag g:name=“DNC” g:value=“” />
                <g:tag g:name=“DPS” g:value=“” />
                <g:tag g:name=“DDI” g:value=“” />
                <g:tag g:name=“GT1” g:value=“” />
                <g:tag g:name=“GT2” g:value=“” />
                <g:tag g:name=“GT3” g:value=“” />
                <g:tag g:name=“GT4” g:value=“” />
                <g:tag g:name=“GT5” g:value=“” />
            </g:link>
        </cp:DATA>
    </cp:CONTENTITEM>
    <cp:CONTENTITEM>
        <cp:ABSTRACT>Sample Text block number 1
        </cp:ABSTRACT>
    </cp:CONTENTITEM>
    <cp:CONTENTITEM>
        <cp:ABSTRACT>Sample Text block number 2
        </cp:ABSTRACT>
    </cp:CONTENTITEM>
    <cp:CONTENTITEM>
        <cp:ABSTRACT>
                <xhtml:p>
                    <xhtml:strong>Bold,</xhtml:strong>
                    <xhtml:em>Italic</xhtml:em>
                    ’
                    <xhtml:u>Underline</xhtml:u>
                    ’
                    <xhtml:a href=“http://www.msn.com”>
                        http://www.msn.com
                    </xhtml:a>
                    ’
                    <xhtml:sup>Superscript</xhtml:sup>
                    ’
                    <xhtml:sub>Subscript</xhtml:sub>
                </xhtml:p>
                <xhtml:ol>
                    <xhtml:li>
                        <xhtml:sub>Item1</xhtml:sub>
                    </xhtml:li>
                    <xhtml:li>
                        <xhtml:sub>Item2</xhtml:sub>
                    </xhtml:li>
                </xhtml:ol>
                <xhtml:ul>
                    <xhtml:li>
                        <xhtml:sub>Bullet1</xhtml:sub>
                    </xhtml:li>
                    <xhtml:li>
                        <xhtml:sub>Bullet2</xhtml:sub>
                    </xhtml:li>
                </xhtml:ul>
                <xhtml:blockquote dir=“ltr” style=
                “MARGIN-RIGHT: 0px”>
                    <xhtml:p>
                        <xhtml:sub>Outdent</xhtml:sub>
                    </xhtml:p>
                </xhtml:blockquote>
            </cp:ABSTRACT>
        </cp:CONTENTITEM>
    </cp:CONTENT>
```

As seen, the content 10 includes seven items 22, including in order two sample text items 22 tagged as headlines, two URL (Universal Resource Locators) items 22 tagged as headlines, two sample text items 22 tagged as abstracts, and one rich text item 22 tagged as an abstract. Presumably, the content 10 was formatted by another process and received therefrom in the formatted form, although the editor at the editing process 28 may also format the content 10 as applied to such editing process 28 without departing from the spirit and scope of the present invention. As also seen, the content 10 does not contain therein any indicia that binds the content 10 to any particular edit form 14, and accordingly such content 10 may be employed in connection with one or more of multiple particular edit forms 14, each having appropriate controls 20 therein.

Thereafter, the editor at the editing process 28 of FIG. 2A selects a dynamic edit form 14 that is to be employed to produce the page 16 as an input to the editing process 28 (step 303). An example of a particular dynamic edit form 14 that is to be inputted to the editing process 28 of FIG. 2A in an XML format is set forth:

```
<?xml version=“1.0” encoding=“utf-8” ?>
<UI FormName=“Generic” Tooltip=“This edit form allows you
to select from the
complete list”>
    <CONTROLS XPath=“CONTENT” type=“ContentDirectives”
    Name=“ContentLimit” customEntry=“Limit#limit”>
        <CONTROL Name=“Root” XPath=“CONTENTITEM”>
            <CONTROL Type=“Textbox” Name=“Headline” Label=
            “Text”
            insertLabel=“Text” elementTag=“Headline”
            minOccurs=“0”
            maxOccurs=“40” customList=“Style#class|Weight#bold”
            customEntry=“Sequence#seq” />
            <CONTROL type=“Link” Name=“Link” label=“Link”
            insertLabel=“Link” displayTextLabel=“Display Text”
            urlLabel=“URL” trackingLabel=“Tracking” elementTag=
            “Link”
            minOccurs=“0” maxOccurs=“40” showLinkDetail=“no”
            showTrackingDetail=“no”
            customList=“Style#class|Weight#bold|Flag#highspeed”
            customEntry=“Sequence#seq” />
            <CONTROL Type=“Data” Name=“TextBlock” Label=
            “Text
            Block” insertLabel=“Text Block” elementTag=“Abstract”
            Rows=“5” minOccurs=“0” maxOccurs=“40” isCDATA=
            “false”
            customEntry=“Sequence#seq” />
            <CONTROL type=“RichText” Name=“RichText” label=
            “Rich
            Text” insertLabel=“Rich Text” rows=“7”
            elementTag=“Abstract” minOccurs=“0” maxOccurs=“40”
            isCDATA=“false” customEntry=“Sequence#seq” />
            <CONTROL type=“Image” Name=“Image” Label=
            “Image”
            insertLabel=“Image” srcLabel=“Image” altTextLabel=“Alt
            Text” widthValue=“20” widthLabel=“Width”
            heightValue=“20”
            heightLabel=“Height” elementTag=“Image”
            minOccurs=“0”
            maxOccurs=“40” customEntry=“Sequence#seq” />
            <CONTROL type=“ImageMap” Name=“ImageMap”
            Label=“Image Map” insertLabel=“Image Map”
            srcLabel=“Image Map” widthValue=“20” widthLabel=
            “Width”
            heightValue=“20” heightLabel=“Height” showDetail=“no”
            mapLabel=“Map” mapBorder=“yes” mapCDATA=“false”
            mapRows=“5” showMap=“yes” elementTag=“Image”
            minOccurs=“0” maxOccurs=“40”
            customEntry=“Sequence#seq” />
            <CONTROL type=“ImageLink” Name=“ImageLink”
            Label=“Image Link” insertLabel=“Image Link”
            srcLabel=“Image Link” altTextLabel=“Alt Text”
            widthValue=“20” widthLabel=“Width” heightValue=“20”
            heightLabel=“Height” urlLabel=“Link”
            trackingLabel=“Tracking” showDetail=“no”
            showLinkDetail=“yes” showTrackingDetail=“yes”
            elementTag=“Image” minOccurs=“0” maxOccurs=“40”
            customEntry=“Sequence#seq” />
        </CONTROL>
    </CONTROLS>
</UI>
```

As seen, the edit form 14 includes seven controls 20, each uniquely typed, including in order a textbox control 20, a link control 20, a data control 20, a rich text control 20, an image control 20, an image map control 20, and an image link control 20. As should be appreciate, the definition of each control 20 and the attributes thereof is set forth elsewhere, and each control 20 corresponds to a graphic display element available from a graphical toolbox or the like.

Presumably, the edit form 14 was formatted by another process and received therefrom in the formatted form, although the editor at the editing process 28 may also format the edit form 14 as applied to such editing process 28 without departing from the spirit and scope of the present invention. As also seen, the edit form 14 does not contain therein any indicia that binds the edit form 14 to any particular content 10, and accordingly such edit form 14 may be employed in connection with one or more of multiple particular types of content 10, each having appropriate items 22 therein.

Significantly, the edit form 14 does not necessarily require that each control 20 therein be employed in producing the page 16 from the content 10. In particular, and as seen, each control 20 includes a ‘minOccurs’ attribute set to 0, meaning that the control need not be used at all in a page 16. Note, too, that each control 20 has a ‘maxOccurs’ attribute set to 40, meaning that up to 40 instances of the control 20 can appear in a page 16 based on such edit form 14. As should be understood, the editor at the edit process 28 after having inputted the edit form 14 can employ the editing process 28 as appropriate to select however many instances of each control 20 are desired for a particular page 16.

Note that each control 20 includes an attribute name—value pair ‘customEntry=“Sequence#seq’. As will be set forth in more detail below, such attribute is set in connection with the layout statement 26 for each instance of the control in a page 16 to define the order of the instance of the control 20 within the page in relation to other instances of controls 20 in the page. Note, too, that at least some of the controls 20 include an attribute ‘customList’ with one or more indicia associated therewith, such as for example ‘Style#class’, ‘Weight#bold’, and ‘Flag#highspeed’. Again, as will be set forth in more detail below, values for such custom indicia can be set in connection with the layout statement 26 for each instance of the control in a page 16 to for example set text in a link as bold. As should be understood, then, the editor at the edit process 28 after having inputted the edit form 14 can employ the editing process 28 and such custom attributes as appropriate to set such custom attributes as desired for a particular page 16.

As yet, nothing exists to tie the content 10 set forth above to the edit form 14 set forth above. As may be appreciated, without such tying, there is practically no way to know that a particular item 22 of content 10 is intended to be displayed in a page 16 according to a particular control 20. Without such tying, then, it could occur that a text item 22 is displayed according to an image control 20, with the result in fact being nonsensical. As was set forth above, in one embodiment of the present invention, such tying is achieved by way of a content-control statement 24. Accordingly, the editor at the editing process 28 of FIG. 2A in conjunction with selecting the edit form 14 as at step 303 also selects a content-control statement 24 that ties the selected content 10 to the selected edit form 14 as an input to the editing process 28 (step 305). An example of a particular content-control statement 24 that is to be inputted to the editing process 28 of FIG. 2A in an XML format is set forth:

```
<?xml version=“1.0” encoding=“utf-8” ?>
<EditForm id=“a57d28a9-c009-47d9-9a00-248e28d0140f”>
    <Control path=“cp:CONTENTITEM[1]” type=“Textbox” />
    <Control path=“cp:CONTENTITEM[2]” type=“Textbox” />
    <Control path=“cp:CONTENTITEM[3]” type=“Link” />
    <Control path=“cp:CONTENTITEM[4]” type=“Link” />
    <Control path=“cp:CONTENTITEM[5]” type=“Data” />
    <Control path=“cp:CONTENTITEM[6]” type=“Data” />
    <Control path=“cp:CONTENTITEM[7]” type=“RichText” />
</EditForm>
```

As seen, the content-control statement 24 sets forth for each of the seven ordered items 22 in the content 10 set forth above a corresponding type, where the type corresponds to a type of control 20 in the edit form 14 set forth above, where the item 22 is thus to be displayed in a page 16 according to the corresponding type of control 20. Thus, each of the first and second items 22 of the content 10, which are the first and second instances of the sample text tagged as headline, are to be displayed in a page 16 according to the ‘textbox’ type of control 20 as set forth in the edit form 14; each of the third and fourth items 22 of the content 10, which are the first and second instances of URLs tagged as headline, are to be displayed in a page 16 according to the ‘link’ type of control 20 as set forth in the edit form 14; each of the fifth and sixth items 22 of the content 10, which are the first and second instances of the sample text tagged as abstract, are to be displayed in a page 16 according to the ‘data’ type of control 20 as set forth in the edit form 14; and the seventh item 22 of the content 10, which is the only instance of rich text tagged as abstract, is to be displayed in a page 16 according to the ‘richtext’ type of control 20 as set forth in the edit form 14.

Note that the content-control statement 24 does not refer to any of the ‘Image’, ‘ImageMap’, or ‘ImageLink’ controls 20 defined in the edit form 14. Accordingly, such non-referenced controls are not used in connection with the content 10. Note, too, that the content-control statement 24 does refer to all of the items 22 defined in the content 10, although that need not necessarily be the case. Accordingly, all of such items 22 can be used, although as seen below the layout statement 26 defines whether each item 22 is actually used in the page 16.

The content-control statement 24 specifically ties the content 10 to a particular edit form 14 identified in the statement 24. Note, though, that it could be the case that the content-control statement 24 ties the content 10 to any edit form 14 having the controls 20 set forth therein. However, inasmuch as such a situation is fairly indefinite, the situation could arise in substantial error, and as a result is not especially desirable.

As yet, content 10, and edit form 14, and a content-control statement 24 tying the content 10 to the edit form 14 have been set forth. However, nothing exists as yet to set forth how each of item 22 of such content 10 is to appear in the page 16 based on the controls 20 set forth in the edit form. Accordingly, a layout statement 26 is either inputted to the editing process 28 for possible modification by the editor at such editing process 28 (step 307), or the editor creates such a layout statement 26 with the aid of the editing process 28 (step 309), where such created or modified layout statement 26 is then outputted and saved (step 311). In any case, an example of a particular layout statement 26 that is to be inputted to or outputted from the editing process 28 of FIG. 2A in an XML format is set forth:

```
<?xml version=“1.0” encoding=“utf-8” ?>
<m:directives xmlns:m=“http://schemas.microsoft.com/msn/marble/cm”
xmlns:cp=“urn:schemas-microsoft-com/contentpublishing/content”>
    <m:directive
    select=“/cp:CONTENT/cp:CONTENTITEM[1]/cp:HEADLINE[1]”
    name=“@class”>default</m:directive>
    <m:directive
    select=“/cp:CONTENT/cp:CONTENTITEM[1]/cp:HEADLINE[1]”
    name=“@bold”>default</m:directive>
    <m:directive select=“/cp:CONTENT/cp:CONTENTITEM[1]”
    name=“@seq”>1</m:directive>
    <m:directive
    select=“/cp:CONTENT/cp:CONTENTITEM[2]/cp:HEADLINE[1]”
    name=“@class”>highlight</m:directive>
    <m:directive
    select=“/cp:CONTENT/cp:CONTENTITEM[2]/cp:HEADLINE[1]”
    name=“@bold”>no</m:directive>
    <m:directive select=“/cp:CONTENT/cp:CONTENTITEM[2]”
    name=“@seq”>2</m:directive>
    <m:directive
    select=“/cp:CONTENT/cp:CONTENTITEM[3]/cp:HEADLINE[1]”
    name=“@class”>default</m:directive>
    <m:directive
    select=“/cp:CONTENT/cp:CONTENTITEM[3]/cp:HEADLINE[1]”
    name=“@bold”>default</m:directive>
    <m:directive select=“/cp:CONTENT/cp:CONTENTITEM[3]”
    name=“@seq”>3</m:directive>
    <m:directive select=“/cp:CONTENT/cp:CONTENTITEM[4]”
    name=“@seq”>4</m:directive>
    <m:directive select=“/cp:CONTENT/cp:CONTENTITEM[5]”
    name=“@seq”>5</m:directive>
</m:directives>
```

As seen, the layout statement 26 includes several layout directives, in this case tagged as <directive>, where each directive is to be carried out with regard to some defined item 22 or sub-item thereof of the content 10. Generally, employing such layout directives aids tremendously in reducing the proliferation of layouts since each layout statement 26 can leverage variable directions and thus be more generic in nature. Note that each directive is used to render/display the final page 16, as opposed to the edit form 14 which is used to edit the content 10.

As also seen, the layout statement 26 sets forth a page 16 based on the content 10 and the edit form 14 that includes only the first through fifth items 22 of the content 10 and not the sixth and seventh items 22 of such content 10, and sequences the order of such items 22 to appear in the page 16 as first, second, third, fourth, fifth. Further, for the first item 22 of content 10, which according to the content-control statement 24 is displayed according to the ‘textbox’ control 20 of the edit form 14, the statement 26 directs that the sub-item tagged ‘headline’ be displayed with the custom indicia ‘Style#class’ of the custom attribute ‘customList’ of such ‘textbox’ control 20 set to ‘default’ and with the custom indicia ‘Weight#bold’ of the custom attribute ‘customList’ of such ‘textbox’ control 20 also set to ‘default’.

In addition, for the second item 22 of content 10, which according to the content-control statement 24 is also displayed according to the ‘textbox’ control 20 of the edit form 14, the statement 26 directs that the sub-item tagged ‘headline’ be displayed with the custom indicia ‘Style#class’ of the custom attribute ‘customList’ of such ‘textbox’ control 20 set to ‘highlight’ and with the custom indicia ‘Weight#bold’ of the custom attribute ‘customList’ of such ‘textbox’ control 20 set to ‘no’. Also, for the third item 22 of content 10, which according to the content-control statement 24 is displayed according to the ‘link’ control 20 of the edit form 14, the statement 26 directs that the sub-item tagged ‘headline’ be displayed with the custom indicia ‘Style#class’ of the custom attribute ‘customList’ of such ‘textbox’ control 20 set to ‘default’ and with the custom indicia ‘Weight#bold’ of the custom attribute ‘customList’ of such ‘textbox’ control 20 also set to ‘default’.

Again, it should be understood that the layout statement 26 specifies each item 22 of the content 10 that is to appear in the page 16, the layout order of such specified items 22 from the content 10 within the page 16 and any defined attributes to be applied to each such laid-out item 22 and/or sub-items thereof. Also again, it is to be noted that the content 10, the edit form 14, and the content-control statement 24 as inputted to the editing process 28 are not modified based on the activities of the editor at such editing process 28. However, the layout statement 26 as inputted to the editing process 28 can be so modified.

With the content 10, the edit form 14, the content-control statement 24, and perhaps the layout statement 26, perhaps modified by the editor at the editing process 28, and again, the editor causes such editing process 28 to output the edited content 10e (step 313) along with the layout statement 26 outputted as at step 311. Again, such edited content 10e is not a page 16 in a particular rendering format 32 such as HTML, but is instead an intermediate form of the content 10 that takes into consideration the edit form 14, the content-control statement 24 and perhaps the layout statement 26, but that has a neutral format such as XML.

At a minimum, the edited content 10e includes those items 22 of the content 10 and only those controls 20 of the edit form 14 that are referenced by the content-control statement 24, although it is to be appreciated that the edited content 10e may also include other necessary information. For example, the edited content 10e may include a reference to the corresponding layout statement 26 if deemed necessary and/or advisable. Alternatively, the layout statement 26 may include a reference to the corresponding edited content 10e again if deemed necessary and/or advisable.

Accordingly, the editor or another may select an appropriate rendering format 32 (step 315), and the edited content 10e and the layout statement 26 may then be applied along with the selected rendering format 32 to the transforming process 30 of FIG. 2B to produce a page 16 based on the content 10 and the layout statement 26 and produced in the applied rendering format 32 (step 317). Note here that the rendering format 32 may be expressed as an XML document or the like. Such page 16 may of course then be stored on the server 18 of FIG. 2B (step 319) to be served over the network 12 in response to a request therefor from a user on the network.

As should now be appreciated, In the present invention, an edit form 14 is dynamic in nature in that such edit form 14 sets forth available controls 20 and for each such control 20 attributes thereof such as a minimum and maximum number thereof that may appear on a page 16 produced based on such edit form 14. Thus, the controls 20 of the edit form 14 are available to an individual such as an editor in defining a page 16 based on content 10, but are not necessarily required to be used, and if used are not necessarily required to be used in any particular order.

Moreover, in the present invention, each of the content 10, the edit form 14, the content-control statement 24, the layout statement 26, and the rendering format 32 are modularized and therefore separate from one another. Accordingly each of the content 10, the edit form 14, the content-control statement 24, the layout statement 26, and the rendering format 32 can be used separately from one another in any conceivable combination with other content 10, edit forms 14, content-control statements 24, layout statements 26, and rendering formats 32, bearing in mind of course that the content 10 is to be tied to the edit form 14 by the content-control statement 24 and that the layout statement 26 is to bear some relation to the content 10, the edit form 14, and the content-control statement 24.

Note that although the process of producing the page 16 is shown in FIGS. 2A and 2B and is set forth above as essentially being linear and non-repeating, it is in fact the case that the process of producing the page 16 can in fact be non-linear and repeating. In particular, it is the case that the edited content 10e as produced by the editing process 28 can in turn be fed back into the editing process 28 along with another edit form 14, another content-control statement 24, and another layout statement 26 to produce another piece of edited content 10e, and that such a feed back loop can be performed multiple times as necessary.

Note too that although the process of producing the page 16 is shown in FIGS. 2A and 2B and is set forth above as being based on a single piece of inputted content 10, it is in fact the case that the process of producing the page 16 can in fact be based on multiple pieces of inputted content 10. In particular, it is the case that each of multiple pieces of content 10 can be incorporated into the page 16 based on the inputted edit form 14. Of course, each such piece of content 10 requires a corresponding content-control statement 24 to tie such piece of content 10 to the edit form 14. Presumably, despite the multiple pieces of content 10 inputted to the editing process 28, only a single piece of edited content 10e is outputted therefrom.

Applying Transforms to the Edited Content 10e

As set forth above, edited content 10e and a layout statement 26 are produced by the edit process 28 of FIG. 2A, and the edited content 10e and layout statement 26 are applied along with a rendering format 32 to the transforming process 30 of FIG. 2B to result in the page 16 in the applied rendering format 32. However, it is to be appreciated that the rendering format 32 is merely one form of transform that may be applied to the edited content 10e by the transforming process 30 to result in the page 16.

In particular, in one embodiment of the present invention, and as seen in FIG. 2B, multiple transforms 32 may be applied to the edited content 10e by the transforming process 30 to result in the page 16. As should now be appreciate, each transform 32 is designed to effectuate a particular change on the edited content 10e and/or the layout thereof as set forth by the layout statement 26 applied with the edited content 10e to the transforming process 30, and where the change is reflected in the page 16 produced by the transform 32.

Each applied transform 32 may be any appropriate transform 32 without departing from the spirit and scope of the present invention. Each such transform 32 should at least be apparent to the relevant public and therefore need not be described herein in any detail. Examples of transforms 32 abound, and may include the aforementioned rendering format 32, a transform 32 for converting one editing style such as bold to another editing style such as italic, a transform 32 for underlining a predefined term, a transform 32 for converting one text color in the edited content 10e to another text color, a transform 32 for adjusting tint in a picture, a transform for modifying or updating text, a transform for adding a sound to and/or removing a sound from the edited content 10e, a transform for adding or modifying a link in the edited content 10e, and the like.

Accordingly, and referring again to FIG. 3, it is seen that in addition to the editor or another selecting an appropriate rendering format/transform 32 as at step 315, such editor or another may also select one or more additional transforms 32 (step 316), and the and the edited content 10e, the layout statement 26, the selected rendering format/transform 32, and the selected additional transforms 32 are applied to the transforming process 30 to produce the page 16, as at step 317. Note here that as with the rendering format/transform 32, the additional transforms 32 may be expressed as an XML document or the like.

As should now be appreciated, In the present invention, the applied transforms 32 are modularized and therefore separate from one another. Accordingly each transform 32 can be used separately from one another in any conceivable combination with other transforms 32, bearing in mind of course that some transforms 32 should not be used with others. For example, two rendering format transforms 32 should not be applied together, especially if the two rendering format transforms 32 are non-mutual.

Note that although the process of producing the page 16 is shown in FIGS. 2A and 2B and is set forth above as essentially being linear and non-repeating, it is in fact the case that the process of producing the page 16 can in fact be non-linear and repeating. In particular, it is the case that the page 16 as produced by the transforming process 28 can in turn be fed back into the transforming process 28 along with one or more other transforms 32 and the like to produce another page 16, and that such a feed back loop can be performed multiple times as necessary.

Note too that although the process of producing the page 16 is shown in FIGS. 2A and 2B and is set forth above as being based on a single piece of edited content 10e, it is in fact the case that the process of producing the page 16 can in fact be based on multiple pieces of edited content 10. In particular, it is the case that each of multiple pieces of edited content 10e can be applied to the transforming process 30. Presumably, despite the multiple pieces of edited content 10 inputted to the transforming process 30, only a single page 16 is outputted therefrom.

Note that with multiple modularized transforms 32, varying forms of edited content 10e or a page 16 may be shared with multiple requesters. Note that while such sharing may be desired, a master may only wish to share a portion of the data incumbent in the edited content 10e or page 16, or else to edit the data 10e/16 according to the type of requester. Thus, and with reference to FIG. 2B, with multiple transforms 32, the master can allow each requester to access the data 10e/16 or a portion thereof without fear that the data 10e/16 itself would be altered.

In one embodiment of the present invention, then, in response to a first requester, the data 10e/16 maybe applied as the input to the transforming process 30 of FIG. 2B along with a first set of transforms 32 to produce a first version of a page 16 for such first requester, while in response to a second requester, the data 10e/16 maybe applied as the input to the transforming process 30 of FIG. 2B along with a second set of transforms 32 to produce a second version of the page 16 for such second requester. Critically, the data 10e/16 is not itself altered, but is instead merely as an input to a transforming process 30.

Note that because the transforms 32 are modular, only those transforms 32 that are required for a particular request are applied to the transforming process 30 to produce the page 16 for responding to such request. More significantly, such multiple transforms 32 can be applied on an ad hoc basis. Thus, no need exists for a multitude of single transforms each representing a particular permutation of a combination of transform functions.

As set forth herein, the editor or the like is a person or other entity that employs a dynamic edit form 14 to edit content 10, and that dynamically modifies the edit form 14 based on the content 10 and the needs and requirements of the edited content 10e. Typically, a developer separate from the editor or the like develops the edit form definition, and the editor employs the developed edit form definition and dynamically modifies same at edit time. However, the developer and the editor or the like may also be one and the same without departing from the spirit and scope of the present invention.

Conclusion

Although the present invention is disclosed primarily in terms of an individual such as an editor operating the editing process 28 of FIG. 2A and/or the transforming process 30 of FIG. 2B, it is to be appreciated that such invention can be used in a more automated manner. For example, it is to be expected that responding to multiple requesters for data 10e/16 with multiple versions of a page 16 from a transforming process 30 is performed in an automated manner. Accordingly, the present invention should not be limited in this regard.

The programming necessary to effectuate the processes performed and structures created in connection with the present invention is relatively straight-forward and should be apparent to the relevant programming public. Accordingly, such programming is not attached hereto. Any particular programming, then, may be employed to effectuate the present invention without departing from the spirit and scope thereof.

In the foregoing description, it can be seen that the present invention comprises a new and useful system that may be employed by an editor or the like to design and modify an edit form in a dynamic manner, and to transform an XML definition of the edit form or the like into an HTML page or the like representing a final rendered user experience. It should be appreciated that changes could be made to the embodiments described above without departing from the inventive concepts thereof. It should be understood, therefore, that this invention is not limited to the particular embodiments disclosed, but it is intended to cover modifications within the spirit and scope of the present invention as defined by the appended claims.

1. A computing system having an editing process operating thereon, the editing process:
receiving a selection of a piece of content, the content including at least one item therein, each item specifying a pre-defined portion of the content;
receiving a selection of an edit form, the edit form including at least one control therein, each control being available for receiving an item of the content and for specifying attributes relating to displaying the received item in a page that is to be served to a requester thereof;
receiving a selection of a content-control statement, the content-control statement specifying for each of at least some items of the content a control from the edit form to be employed to display the item in the page and thereby binding the content to the edit form;
performing one of receiving a selection of a layout statement or allowing an editor to create the layout statement, the layout statement specifying each item of the content that is to appear in the page, including a layout order of such specified item within the page and any attributes to be applied to such item;
facilitating the editor in editing the layout statement to edit how the content is to appear in the page; and
outputting the edited layout statement and edited content, the edited content being an intermediate form of the content based on at least the edit form and the content-control statement, wherein a transforming process is to produce the page based on the edited content, the layout information, and a pre-selected rendering format.

2. The computing system of claim 1 wherein the editing process includes a user interface (UI) setting forth editable attributes of the edit form, a UI setting forth each item of content, a UI setting forth the content-control statement, a UI setting forth the layout statement, and a UI setting forth the page based on the content, the edit form, the content-control statement, and the layout statement.

3. The computing system of claim 2 wherein the UI for each of the piece of content represents same in a graphical form.

4. The computing system of claim 1 wherein the editing process receives each of the piece of content, the edit form, the content-control statement, and the layout statement in an computer-based markup language.

5. The computer system of claim 1 wherein the editing process outputs the edited content in a neutral format not specific to any particular rendering format.

6. The computing system of claim 1 wherein the editing process outputs the edited content as an intermediate form of the content based on at least the edit form, the content-control statement, and the layout statement.

7. The computing system of claim 1 wherein the editing process outputs the edited content as an intermediate form of the content without taking into consideration the layout statement.

8. The computing system of claim 1 wherein the editing process outputs the edited content as an intermediate form of the content including the items of the content and the controls of the edit form that are referenced by the content-control statement.

9. The computing system of claim 1 wherein the editing process receives the content without any indicia that binds such content to any particular edit form.

10. The computing system of claim 1 wherein the editing process receives the edit form without any indicia that binds such edit form to any particular contact.

11. The computing system of claim 1 wherein the editing process receives a selection of an edit form with a control that specifies at least one of a minimum and a maximum number of instances of the control that can appear in a page based on the edit form, and facilitates the editor to select however many instances of the control are desired for the page.

12. The computing system of claim 1 wherein the editing process receives a selection of an edit form with a control that specifies a sequence attribute for an instance of the control that appears in a page based on the edit form, and facilitates the editor in editing the layout statement to specify a value for the sequence attribute to define a position of the instance of the control within the page in relation to other instances of controls in the page.

13. The computing system of claim 1 wherein the editing process receives a selection of an edit form with a control that specifies a custom attribute for an instance of the control that appears in a page based on the edit form, and facilitates the editor in editing the layout statement to specify a value for the custom attribute.

14. The computing system of claim 1 wherein the editing process further:
receives a selection of the edited content;
receives another selection of an edit form;
receiving another selection of a content-control statement;
performing one of receiving another selection of a layout statement or allowing an editor to create another layout statement;
facilitating the editor in editing the another layout statement; and
outputting the edited another layout statement and further edited content.

15. The computing system of claim 1 wherein the editing process:
receives a selection of a plurality of pieces of content, each piece of content including at least one item therein;
receiving a selection of an edit form, the edit form including at least one control therein, each control being available for receiving an item of one of the pieces of content;
receiving a selection of a content-control statement corresponding to each selected piece of content, each content-control statement specifying for each of at least some items of the corresponding piece of content a control from the edit form to be employed to display the item in the page and thereby binding the corresponding piece of content to the edit form;
performing one of receiving a selection of a layout statement or allowing an editor to create the layout statement, the layout statement specifying each item of each piece of content that is to appear in the page, including a layout order of such specified item within the page and any attributes to be applied to such item;
facilitating the editor in editing the layout statement to edit how each piece of the content is to appear in the page; and
outputting the edited layout statement and a piece of edited content, the edited content being an intermediate form of each piece of content based on at least the edit form and each corresponding content-control statement.

16. A computer-readable medium having stored thereon computer-executable instructions implementing an editing process operating on a computer system, the editing process:
receiving a selection of a piece of content, the content including at least one item therein, each item specifying a pre-defined portion of the content;
receiving a selection of an edit form, the edit form including at least one control therein, each control being available for receiving an item of the content and for specifying attributes relating to displaying the received item in a page that is to be served to a requester thereof;
receiving a selection of a content-control statement, the content-control statement specifying for each of at least some items of the content a control from the edit form to be employed to display the item in the page and thereby binding the content to the edit form;
performing one of receiving a selection of a layout statement or allowing an editor to create the layout statement, the layout statement specifying each item of the content that is to appear in the page, including a layout order of such specified item within the page and any attributes to be applied to such item;
facilitating the editor in editing the layout statement to edit how the content is to appear in the page; and
outputting the edited layout statement and edited content, the edited content being an intermediate form of the content based on at least the edit form and the content-control statement, wherein a transforming process is to produce the page based on the edited content, the layout information, and a pre-selected rendering format.

17. The medium of claim 16 wherein the editing process includes a user interface (UI) setting forth editable attributes of the edit form, a UI setting forth each item of content, a UI setting forth the content-control statement, a UI setting forth the layout statement, and a UI setting forth the page based on the content, the edit form, the content-control statement, and the layout statement.

18. The medium of claim 17 wherein the UI for each of the piece of content represents same in a graphical form.

19. The medium of claim 16 wherein the editing process receives each of the piece of content, the edit form, the content-control statement, and the layout statement in an computer-based markup language.

20. The medium of claim 16 wherein the editing process outputs the edited content in a neutral format not specific to any particular rendering format.

21. The medium of claim 16 wherein the editing process outputs the edited content as an intermediate form of the content based on at least the edit form, the content-control statement, and the layout statement.

22. The medium of claim 16 wherein the editing process outputs the edited content as an intermediate form of the content without taking into consideration the layout statement.

23. The medium of claim 16 wherein the editing process outputs the edited content as an intermediate form of the content including the items of the content and the controls of the edit form that are referenced by the content-control statement.

24. The medium of claim 16 wherein the editing process receives the content without any indicia that binds such content to any particular edit form.

25. The medium of claim 16 wherein the editing process receives the edit form without any indicia that binds such edit form to any particular contact.

26. The medium of claim 16 wherein the editing process receives a selection of an edit form with a control that specifies at least one of a minimum and a maximum number of instances of the control that can appear in a page based on the edit form, and facilitates the editor to select however many instances of the control are desired for the page.

27. The medium of claim 16 wherein the editing process receives a selection of an edit form with a control that specifies a sequence attribute for an instance of the control that appears in a page based on the edit form, and facilitates the editor in editing the layout statement to specify a value for the sequence attribute to define a position of the instance of the control within the page in relation to other instances of controls in the page.

28. The medium of claim 16 wherein the editing process receives a selection of an edit form with a control that specifies a custom attribute for an instance of the control that appears in a page based on the edit form, and facilitates the editor in editing the layout statement to specify a value for the custom attribute.

29. The medium of claim 16 wherein the editing process further:
receives a selection of the edited content;
receives another selection of an edit form;
receiving another selection of a content-control statement;
performing one of receiving another selection of a layout statement or allowing an editor to create another layout statement;
facilitating the editor in editing the another layout statement; and
outputting the edited another layout statement and further edited content.

30. The medium of claim 16 wherein the editing process:
receives a selection of a plurality of pieces of content, each piece of content including at least one item therein;
receiving a selection of an edit form, the edit form including at least one control therein, each control being available for receiving an item of one of the pieces of content;
receiving a selection of a content-control statement corresponding to each selected piece of content, each content-control statement specifying for each of at least some items of the corresponding piece of content a control from the edit form to be employed to display the item in the page and thereby binding the corresponding piece of content to the edit form;
performing one of receiving a selection of a layout statement or allowing an editor to create the layout statement, the layout statement specifying each item of each piece of content that is to appear in the page, including a layout order of such specified item within the page and any attributes to be applied to such item;
facilitating the editor in editing the layout statement to edit how each piece of the content is to appear in the page; and
outputting the edited layout statement and a piece of edited content, the edited content being an intermediate form of each piece of content based on at least the edit form and each corresponding content-control statement.
